(19) United States
(12) Patent Application Publication
(10) Pub. No.: US 2004/0252819 A1
(43) Pub. Date: Dec. 16, 2004

(54) Input unit and input method using it

(76) Inventor: Hitoshi Miyata, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/485,556

(22) PCT Filed: Sep. 7, 2001
(86) PCT No.: PCT/JP01/07788

(30) Foreign Application Priority Data
Aug. 3, 2001 (JP) 2001-235994

(51) Int. Cl. H04M 3/42

(52) U.S. Cl. 379/201.01

(57) ABSTRACT

The present invention relates to an input device and an input method which can simplify input operations of characters including alphanumeric characters and input operations of command codes such as passwords, etc.

As operation keys, a multidirectional operation key input device (4) that can be operated forward, rearward, rightward, and leftward is adopted, and an operating part of this multidirectional operation key input device is operated so as to draw a predetermined operation track, whereby a predetermined character, etc., can be inputted.

As a result, the input operation of a character, etc., can be simplified, and therefore, the invention contributes to further improvement in multi-functionality of electronics devices without an increase in the number of operation keys and without an increase in the number of operation processes of the operation keys.

### FIELD OF THE INVENTION

The present invention relates to an input device and an input method which can simplify input operations for inputting characters such as alphanumeric characters and hiragana characters and input operations for inputting command codes of passwords, etc.

### RELATED ART

Generally, in mobile devices such as a PHS and a cell phone, etc., game machines, and personal computers, input devices are provided for input operations for inputting characters such as alphanumeric characters and hiragana characters, etc., and input operations for inputting command codes of passwords, etc.

For example, in a cell phone, the phone main body is provided with (1) a display device for displaying a telephone number, etc., of another station and (2) an input device with a number of operation keys for inputting a telephone number, etc., of another station. In a personal computer, various input operations can be carried out by using a keyboard.

The present invention is applicable to all electronics devices including mobile devices, game machines, and personal computers that generally require keys for inputting various characters and numerals, and as a prior art to be compared with the present invention herein, a cell phone is focused on and described below.

Originally, the abovementioned cell phone was developed for the purpose of enabling calls with another station even when a local station moved, and therefore, provision of functions associated with calls and security was sufficient for general cell phones during the initial development of these. These functions are executed in response to inputs of required command codes.

Here, detailed examples of the functions associated with calls are (1) a (redial) function which makes a call by using dial history, (2) a function which makes a call by using received call history, (3) a function which makes a call by using a memory dial (private address book) in which a necessary number of telephone numbers have been registered, (4) a function which selects or changes incoming patterns, and so on. On the other hand, detailed examples of functions associated with security include a function which locks and releases the lock, and so on.

Along with recent information infrastructure-building, various cell phones that have been digitized or mobile-computerized, that is, so-called next-generation cell phones have been proposed. With such next-generation cell phones, (1) e-mail can be exchanged through networks (including the Internet), and (2) desired information is acquired through networks.

Such a next-generation cell phone is provided with (1) a function which displays a shortcut menu associated with functions that can be used in this cell phone under conditions requiring them, (2) a function which displays a bookmark menu in which Internet addresses of web pages which are frequently accessed, and so on are registered. These functions are executed in response to inputs of required command codes in the same manner as the abovementioned original functions of the cell phone.

As concrete input devices in the abovementioned cell phone, button switches with numerals and characters printed on the button surfaces and a multidirectional operation key input device for function selection for selecting various functions are provided.

However, in the abovementioned next-generation cell phone, the following problem has been pointed out.

Namely, due to the variety of provided functions, the systematic aggregation of codes composing the command codes serving as triggers of execution of the respective functions has been complicated. Therefore, to input a command code, a number of operation keys must be operated. As a result, an input operation of a command code is troublesome in an actual situation.

Such a problem is one of the important problems in next-generation cell phones whose functions are expected to increase further in the future along with increasing infrastructure-building. The reason for this is as follows.

Namely, it is inevitable that the systematic aggregation of codes of command codes becomes more complicated. To cope with this, under the present circumstances, it is inevitable that the number of operation keys is increased, or the number of operation processes with operation keys is increased and users are required to carry out troublesome operations. On the other hand, in the designing of cell phones, downsizing, weight saving, and reduction in thickness are essential requirements. Therefore, increasing the number of operation keys for improving multi-functionality of next-generation cell phones cannot be adopted. Even if improvement in multi-functionality is realized by increasing the number of operation processes with operation keys, the realized cell phones are tricky for users to use.

Therefore, the present inventor hit on an idea that a multidirectional operation key input device which realized operations forward, rearward, rightward, and leftward be adopted, and an operating part of this multidirectional operation key input device be operated so that its operation track traced a shape of a character, a numeral, or a code of a command code (in a user's image of each code imagined in his/her mind), whereby the abovementioned problem could be solved without an increase in the number of operation keys or the number of operation processes.

### SUMMARY OF THE INVENTION

The present invention was made on the basis of the above-mentioned idea, and a first object thereof is to provide an input device and an input method using this input device which simplify input operations of the respective codes, and contribute to further improvement in multi-functionality without an increase in the number of operation keys.

Furthermore, the inventor considered that when an input form in which “the multidirectional operation key operating part was operated so that its operation track traced a shape of each code composing a command code” was adopted on the basis of the abovementioned idea, in particular, the abovementioned multidirectional operation key input device movable in all 360° directions (for example, the analog stick of the controller of PlayStation 2 released by Sony Corporation) was adopted, although fine movements were possible with this input device, the habits of a person who inputted greatly influenced, so that adjustments to a degree that allowed variations among persons who inputted must be fully considered, or input variations among persons who inputted must be made smaller.

Therefore, in order to make the input variations smaller, the inventor focused on a point that, while displaying an image equivalent to a template, by displaying a pointer (pointer image) following an operation track along the template, the input variations among users are reduced.

The present invention was made on the basis of the above-mentioned idea, and a second object thereof is to provide an input device and an input method using this input device which reduces input errors by reducing input variations among persons who make inputs while achieving the first object mentioned above.

In order to achieve the abovementioned objects, the invention is characterized in that control is made to enable inputs of predetermined characters, etc., by operating an operating part of a multidirectional operation key input device so as to draw a predetermined operation track, and a display device displays a template which restricts operation tracks within a certain range, and displays a pointer following the operation tracks with respect to the template.

In detail, the present invention provides:

(1) An input device for inputting characters, numerals, or command codes serving as triggers of execution of various functions into an electronics device with a display device that displays required information, wherein a multidirectional operation key input device having an operating part that can be operated in a multidirectional manner is included, and a predetermined character, numeral, or command code serving as a trigger of execution of various functions is inputted by operating the operating part of the multidirectional operation key input device so as to draw a predetermined operation track.

According to the invention, an input operation of a character, a numeral, or a command code can be carried out by only the multidirectional operation key input device, and only one multidirectional operation key input device can bear input functions of conventional multiple button switches.

For example, in a conventional cell phone, to input a character “C”, it is necessary that a “2”-printed button switch is depressed three times (or six times depending on distinction between a capital letter or a small letter) after the character type is changed to “English letter”. However, the invention has an advantage in that by making an operation for the letter “C” by operating the multidirectional operation key input device so as to draw the letter with a single stroke, it becomes possible to reduce the number of operations to complete input, and the number of inputs to complete inputting is also reduced.

In addition, the conceptual operating input which is made by searching for a button marked with “C” and depressing it after changing the character type is changed to a sensory operating input which is made by tracing a predetermined track upon memorizing the predetermined track, and this intuitive operating input becomes easy for a user when the user becomes used to it.

As a result, an input operation of a character, a numeral, or a command code can be simplified, and this contributes to further improvement in multi-functionality of electronics devices without an increase in the number of operation keys and without an increase in the number of operation processes of the operation keys.

(2) The input device according to the above (1) of the invention, wherein the display device displays a reference guide mark which restricts the operation track within a certain range, and displays an operation track according to an operation of the multidirectional operation key input device on the reference guide mark.

According to the invention, the display device displays a reference guide mark and an operation track, and a user operates the multidirectional operation key input device while looking at the track drawn by a pointer that moves by being restricted within the reference guide mark, so that input errors in inputting a character, a numeral, or a command code serving as a trigger of execution of various functions can be prevented.

Herein, “a reference guide mark which restricts operation tracks within a certain range” may be a template, a plurality of reference lines in a grid, or a circular region in which the operating part of the multidirectional operation key input device is movable.

Furthermore, “restricts” means forcible restriction to display a pointer that always follows the operation of the multidirectional operation key input device in a movable area of the pointer, and such restriction becomes possible when “a range of an effective movable operation region of the operating part of the multidirectional operation key input device is set and an operation track that moves within the range of the region according to the operation track of the multidirectional operation key input device can be overwritten and displayed on this range.”

Furthermore, according to the above (1) and (2) of the invention, in view of input error prevention, it is preferable that the reference guide mark and the operation track are displayed on the display device, however, if a user becomes used to the operation of the multidirectional operation key input device, input assistant measures such as the reference guide mark and the operation track become unnecessary, so that only (1) of the invention is applicable. Modes for selecting whether or not these reference guide mark and operation track are to be displayed on the display device can be added to the input device.

Furthermore, in a case were “a command code for locking and releasing the lock” is to be inputted for user identification, the above (1) of the invention in which neither reference guide mark nor operation track are displayed on the display device is preferable to prevent other persons from stealing a glance at the input track.

(3) The input device according to the above (2), wherein an operation track drawn on the reference guide mark is continuously displayed until input of a predetermined character, numeral, or command code serving as a trigger of execution of various functions is completed, and when input of this predetermined character, numeral, or command code serving as a trigger of execution of various functions is completed, this operation track is erased.

According to the invention, by continuously displaying the operation track until input of a certain character, etc., is completed, a movement track as a residual image-like pointer is displayed on the reference guide mark of the display screen, and this makes it possible to more securely prevent input errors.

For example, when a user wants to input a letter “L,” he/she moves the multidirectional operation key input device in the shape of “L” to draw the operation track L on the reference guide mark, and the operation track is continuously displayed until the letter “L” is inputted. Then, when the input of the letter “L” is completed, the operation track displayed on the reference guide mark is erased. When a certain character is thus inputted, its operation track is erased, and thereafter, input of the next character becomes possible.

(4) The input device according to any one of the above (1) to (3), wherein the operating part of the multidirectional operation key input device is formed into an 8-directional operation key input device that can be tilted and pressed forward, rearward, rightward, and leftward or a multidirectional stick-type key input device that is movable. 360 degrees.

According to the invention, by employing an 8-directional operation key input device or a multidirectional stick-type key input device movable 360° which has been conventionally adopted in game machines, more input patterns can be inputted with one multidirectional operation key input device, and this contributes to a reduction in the number of input switches. Therefore, by reducing the number of input switches, the display screen can be increased in size accordingly.

(5) The input device according to any one of the above (1) to (4), further including: comparison data storing characters, numerals, or command codes that serve as triggers of various functions; a recognition means for recognizing a character, a numeral, or a command code corresponding to an inputted operation track by comparing the operation track of the operating part of the multidirectional operation key input device according to the input operation of the predetermined character, numeral, or command code and a character, a numeral, or a command code stored in advance in the comparison data in response to the operation of the operating part of the multidirectional operation key input device; and a display control means for making the display device to display a display image related to the character, the numeral, or the command code when the inputted command code is recognized by this recognition means.

According to the invention, in response to an operation of the operating part of the multidirectional operation key input device, when an inputted character, numeral, or command code is recognized by the recognition means that recognizes a character, a numeral, or a command code corresponding to an inputted operation trace through comparison between an operation track of the operating part of the multidirectional operation key input device according to the input operation of the predetermined character, numeral, or command code and a character, a numeral, or a command code stored in advance in the comparison data, a display image related to the character, the numeral, or the command code is displayed on the display device by the display control means, so that a user can know the results of the input operation of the character, the numeral, or the command code.

(6) The input device according to any one of the above (1) to (5), wherein the multidirectional operation key input device has an operating part which can be operated in a multidirectional manner, that is, at least in forward, rearward, rightward, leftward, and circumferential directions, and by operating the operating part of the multidirectional operation key input device so as to draw a predetermined operation track, that is, an operation track describing a character, a numeral, or a command code itself to be inputted by moving operations forward, rearward, rightward, leftward and circumferential directions of the operating part, this character, numeral, or command code serving as a trigger of execution of various functions is inputted.

According to the invention, the multidirectional operation key input device has an operating part that can be operated in a multidirectional manner, at least in forward, rearward, rightward, leftward and circumferential directions, and as such a multidirectional operation key input device, a multidirectional stick-type key input device that is movable 360° can be used, and smooth track display becomes possible. Furthermore, an operation to draw an operation track describing a character, a numeral, or a command code itself to be inputted is carried out, so that it is preferable that an operation track that a user can grasp and memorize is as easily as possible unless the track agrees with the track of another character, numeral, or command code.

In the multidirectional stick-type key input device that is movable 360 degrees, control can be made so that a certain character, numeral, or command code serving as a trigger of execution of various functions can be inputted by utilizing the stick motion in that the stick always returns to the neutral position (center) when a user leaves his/her hand from the key.

(7) The input device according to any one of the above (1) to (6), wherein the input device is provided in a cell phone, and has, as the command codes, at least one of the command codes for: (i) locking and releasing the lock, (ii) displaying a shortcut menu related to functions of the cell phone which can be used in necessary conditions on the display device, (iii) displaying a bookmark menu in which Internet addresses of web pages which are frequently accessed have been registered on the display device, (iv) displaying an address book in which private information including telephone numbers and e-mail addresses have been registered on the display device, (v) displaying dial history indicating history of dialing by the cell phone on the display device, (vi) displaying received call history indicating history of calls received by the cell phone on the display device, (vii) displaying incoming mails received by the cell phone on the display device, and (viii) displaying outgoing mails transmitted by the cell phone on the display device.

According to the invention, main functions of the cell phone are used for describing detailed examples of command codes, and simultaneous call of the main functions is possible by using only the above-mentioned multidirectional operation key input device as an input device provided in the cell phone.

For the abovementioned input device, the invention also provides the following input method.

(8) An input method for inputting a character, a numeral, or a command code serving as a trigger of execution of various functions into an electronics device including a display device for displaying required information and a multidirectional operation key input device with an operating part that can be operated forward, rearward, rightward, and leftward, including: an input step for inputting a predetermined character, a numeral, or a command code serving as a trigger of execution of various functions by operating the operating part of the multidirectional operation key input device so as to draw a predetermined operation track.

(9) The input method according to the above (8), wherein for a reference guide mark that restricts the operation track within a certain range, a range of an effective movable operation region of the operating part of the multidirectional operation key input device is set, the method further including a step in which the operation track that moves in the range of the region according to an operation track of the multidirectional operation key input device is capable of being overwritten and displayed in the range.

(10) The input method according to the above (9), including: a step in which an operation track to be drawn on the reference guide mark is continuously displayed until input of a predetermined character, a numeral, or a command code serving as a trigger of execution of various functions is completed; and a step in which the track is erased when input of the predetermined character, the numeral, or the command code serving as a trigger of execution of various functions is completed.

(11) The input method according to any one of the above (8) to (10), wherein the operating part of the multidirectional operation key input device is an 8-directional operation key input device that can be tilted and pressed forward, rearward, rightward, and leftward, or a multidirectional stick-type key input device movable 360 degrees, and input can be made by tilting and pressing the operating part forward, rearward, rightward, and leftward.

(12) The input method according to any one of the above (8) to (11), further including: a recognition step in which in response to operation of the operating part of the multidirectional operation key input device, a character, a numeral, or a command code corresponding to the inputted operation track is recognized by comparing the operation track of the operating part of the multidirectional operation key input device according to the input operation of the predetermined character, the numeral, or the command code and comparison data of a character, a numeral, or a command code stored in advance; and a display control step in which the display device is made to display a display image related to the character, the numeral, or the command code when the inputted command code is recognized by this recognition step.

(13) The input method according to any one of the above (8) to (12), wherein the multidirectional operation key input device has an operating part that can be operated in a multidirectional manner, that is, at least in the forward, rearward, leftward, rightward, and circumferential directions, and an input step is included in which a predetermined character, a numeral, or a command code serving as a trigger of execution of various functions is inputted by operating the operating part of the multidirectional operation key input device so as to draw an operation track describing the character, the numeral, or the command code itself to be inputted by moving operations of the operating part in forward, rearward, rightward, leftward, and circumferential directions.

(14) The input method according to any one of the above (8) to (13), wherein the input device is provided in a cell phone, and has, as the command codes, at least one of the command codes for: (i) locking and releasing the lock, (ii) displaying a shortcut menu related to functions of the cell phone which can be used in necessary conditions on the display device, (iii) displaying a bookmark menu in which Internet addresses of web pages which are frequently accessed have been registered on the display device, (iv) displaying an address book in which private information including telephone numbers and e-mail addresses have been registered on the display device, (v) displaying dial history indicating history of dialing by the cell phone on the display device, (vi) displaying received call history indicating history of calls received by the cell phone on the display device, (vii) displaying incoming mails received by the cell phone on the display device, and (viii) displaying outgoing mails transmitted by the cell phone on the display device.

### BRIEF DESCRIPTION OF THE DRAWINGS

FIG. 1 is a perspective view showing an external construction of a cell phone relating to an embodiment of the invention.

FIG. 2 is a main part exploded perspective view of the cell phone.

FIG. 3 is a sectional view along the A-A line of FIG. 2.

FIG. 4 is a sectional view along the B-B line of FIG. 2.

FIG. 5 is an E-portion enlarged perspective view of FIG. 3.

FIG. 6 is a sectional view showing a condition where a pressure is applied to a push key.

FIG. 7 is a sectional view showing a condition where a pressure is applied to an upper portion of a second rotation member.

FIG. 8 is a sectional view showing a condition where a pressure is applied to another upper portion of the second rotation member.

FIG. 9 is a block diagram showing an electrical construction of a main part system of the cell phone.

FIG. 10 is a flowchart showing a flow of processes relating to input of lock setting/releasing codes.

FIG. 11 is a flowchart showing a flow of processes relating to input of a shortcut menu display/cancel code.

FIG. 12 is a flowchart showing a flow of processes relating to inputs of a bookmark menu display/cancel code.

FIG. 13 is a flowchart showing a flow of processes relating to a character input.

FIG. 14A is a drawing showing an example of a reference guide mark P to be displayed on a display 6, and FIG. 14B and FIG. 14C are drawings showing examples of mode switching input operations.

FIG. 15 are drawings showing examples of input operations relating to the embodiment of the invention.

FIG. 16 are drawings showing examples of input operations relating to the embodiment of the invention.

### DETAILED DESCRIPTION OF THE INVENTION

An embodiment of the invention is described with reference to the drawings. In the embodiment described below, an electronics device applied to a cell phone is illustrated as an electronics device of the invention, however, the invention is not limited to this, and as a matter of course, it is applicable to other electronics devices such as other mobile terminals or personal computers.

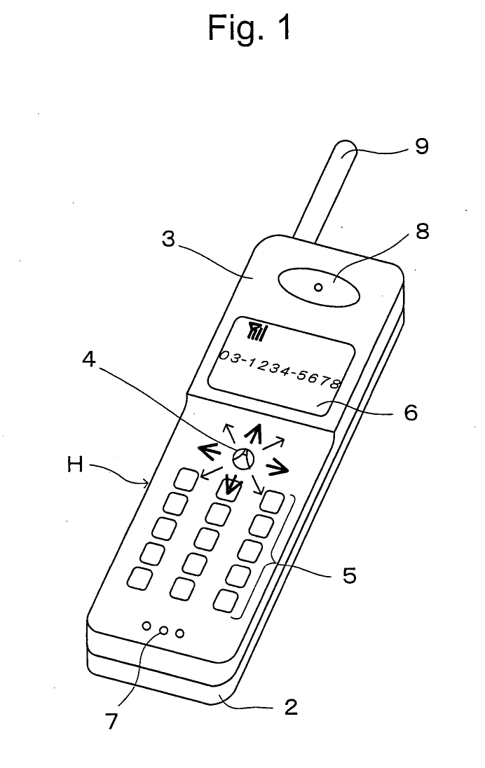

Referring to FIG. 1, the cell phone relating to this embodiment has a phone main body H comprising: an external antenna 9, an ear piece 8 for listening to a voice from another station when a user answers the phone, a display 6 for displaying various function settings and telephone numbers, etc., an 8-directional operation key input device 4 for adjusting the ringtone volume and the call volume, displaying contents of the memory dial on the display 6 in a required status, and selecting various function settings, an operation key group 5 including a dial key input device that is used to input telephone numbers and characters, etc., and a mouthpiece 7 for transmitting voice from the local station during a call.

The phone main body H forms the outer package of the cell phone. This phone main body H is divided into two members, a case 2 for housing predetermined inner parts (including electrical components) and a cover 3 for covering the inner parts housed in the case 2, and the phone main body H is constructed by fitting the case 2 and the cover 3 with each other in a condition where the case 2 houses the inner parts.

The external antenna 9 projects forward from the front end left side of the phone main body H while being sandwiched by the case 2 and the cover 3.

The ear piece 8 is formed at a front portion of the cover 3 while the mouthpiece 7 is formed at a rear portion of the cover 3.

The display surface of the display 6 is exposed from the cover 3 at a lower position of the ear piece 8, and on the other hand, the operation surface of the operation key group 5 is exposed from the cover 3 at an upper position of the mouthpiece 7.

The 8-directional operation key input device 4 is disposed between the display 6 and the operation key group 5 at a central portion of the width direction of the phone main body H so that operations by a thumb become easy when a user holds the phone main body H for communications.

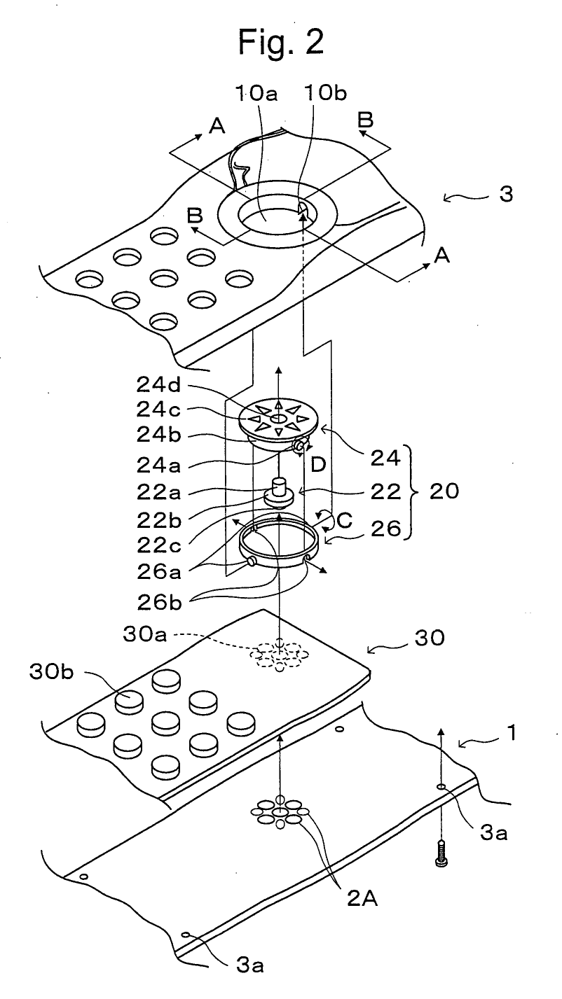

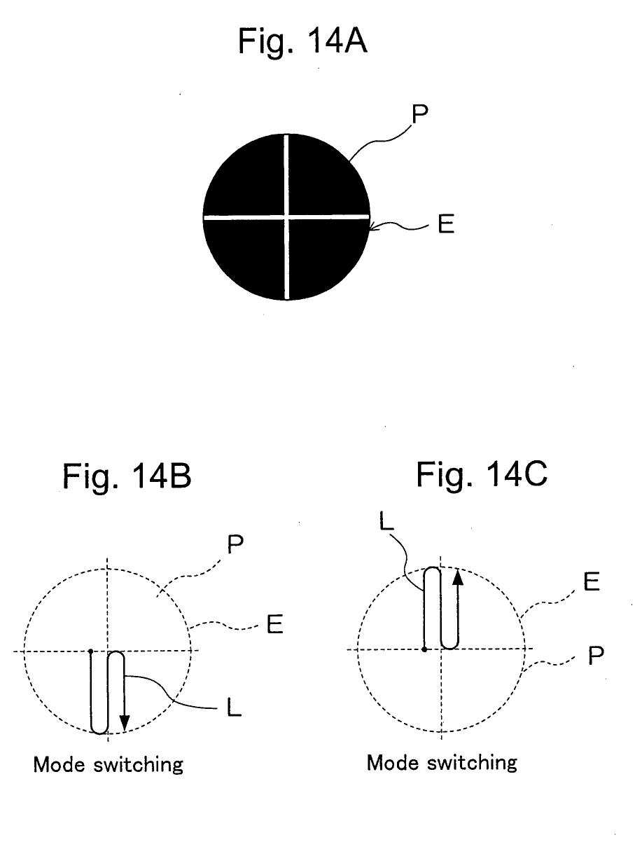

Referring to FIG. 2, this 8-directional operation key input device 4 is mounted on the cover 3, comprises an operating part 20 that tilts forward and rearward and sinks downward, a circuit board 1A including nine leaf spring contacts 2A that are turned on and off by tilting and sinking a key top 30, and a key top 30 disposed between the operating part 20 and the circuit board 1A, and by tilting and pressing the operating part 20 so that the track of this operation draws a character, a numeral, or each code composing a command code (including a character, a numeral, and a simple figure), the character, the numeral, or the command code can be inputted without displaying the reference guide mark. Examples of such input operations of command codes are shown in FIG. 14 to FIG. 16, and detailed description of these are as follows.

Namely, in FIG. 14, FIG. 14A shows an example of a reference guide mark P to be displayed on the display 6, and FIG. 14B and FIG. 14C show examples of mode switching input operations.

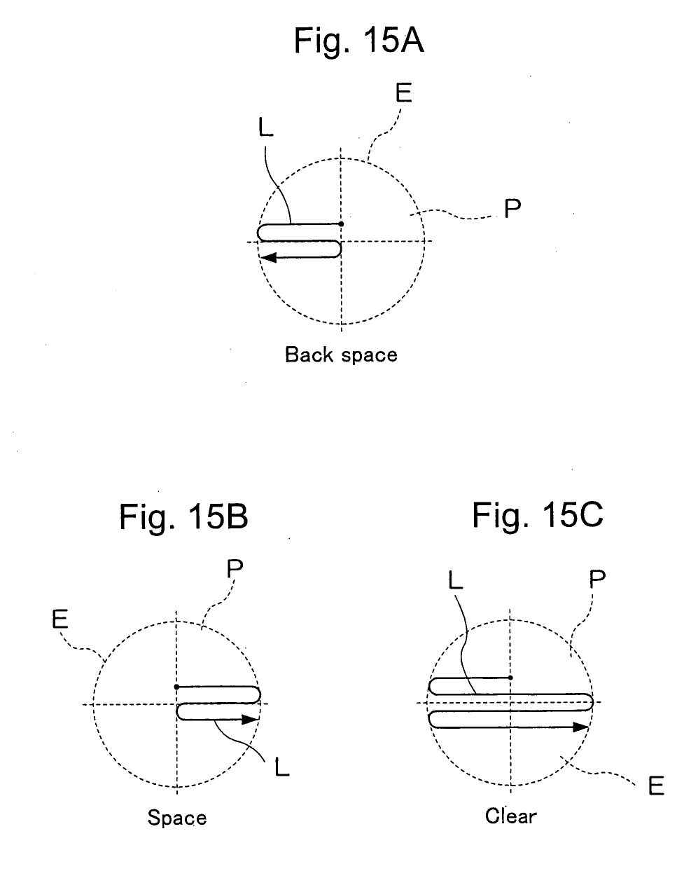

In FIG. 15, FIG. 15A shows an example of a back space input operation, FIG. 15B shows an example of a space input operation, and FIG. 15C shows an example of a clear input operation.

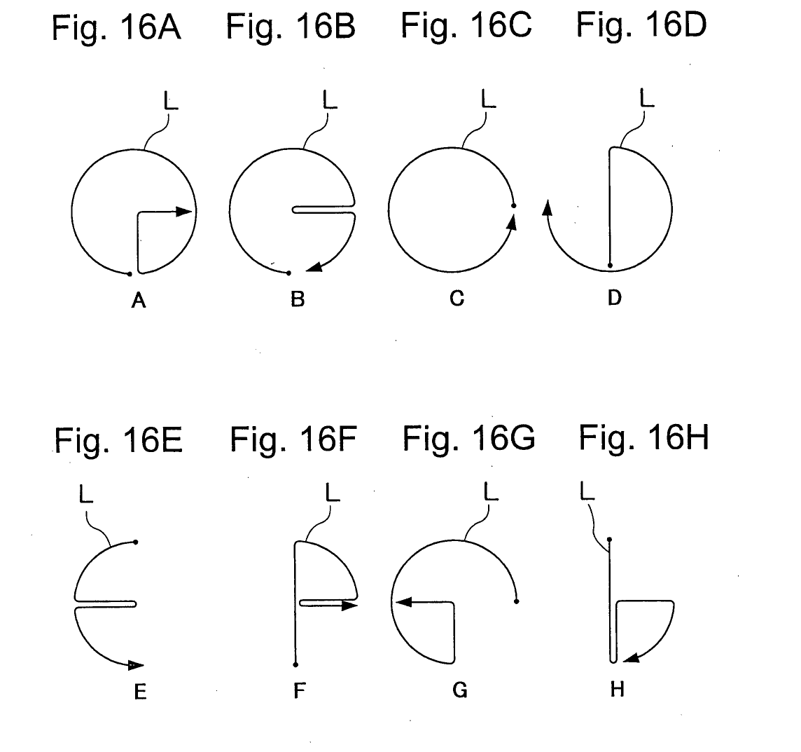

In FIG. 16, FIG. 16A shows an example of a letter A input operation, FIG. 16B shows an example of a letter B input operation, FIG. 16C shows an example of a letter C input operation, FIG. 16D shows an example of a letter D input operation, FIG. 16E shows an example of a letter E input operation, FIG. 16F shows an example of a letter F input operation, FIG. 16G shows an example of a letter G input operation, FIG. 16H shows an example of a letter H input operation.

In these input operations, an operation track L is shown by a solid line in FIG. 14 to FIG. 16, and a reference guide mark P is shown by a dotted circle and cross line in FIG. 14B, FIG. 14C, and FIG. 15A to FIG. 15C. Namely, a region shown by the dotted lines is “the reference guide mark that restricts operations so that the operation track L falls within a certain range.” Therefore, even when the 8-directional operation key input device 4 is operated so as to deviate from the region, a pointer corresponding to the operation track of this operation is prevented from being displayed while deviating from the region, and the operation of the 8-directional operation key input device 4 which deviates from the region E is restricted so as to be ignored.

Furthermore, as shown in FIG. 16A to FIG. 16H, in the case where alphabets “A” to “H” are inputted, since the operation track L is predetermined so that each letter can be quickly inputted in the image of single-stroke writing of the letter, it becomes easy for a user to memorize the operation track L and reproduce it. By predetermining the operation tracks L for “I” through “Z” as well as “A” through “H”, input of all letters becomes possible. Likewise, by predetermining the operation tracks L for “0” through “9”, input of all numerals also becomes possible.

FIG. 14A shows an effective movable operation range E shown by a dotted circle in FIG. 14B and FIG. 14C, which is displayed on the display 6 in a default status before a character, a numeral, or a command code is inputted by the input device 4.

In FIG. 2, between a display mounting part and an operation key group mounting part of the cover 3, at the central portion in the width direction, a hole 10a for inserting the operating part 20 of the 8-directional operation key input device 4 is formed. This hole 10a has a circular shape, and opens vertically. At both ends of the lower side in the longitudinal direction of the circumferential wall of the hole 10a, a pair of notches 10b for mounting the abovementioned operating part 20 are formed. These notches 10b have semicircular shapes, and open downward.

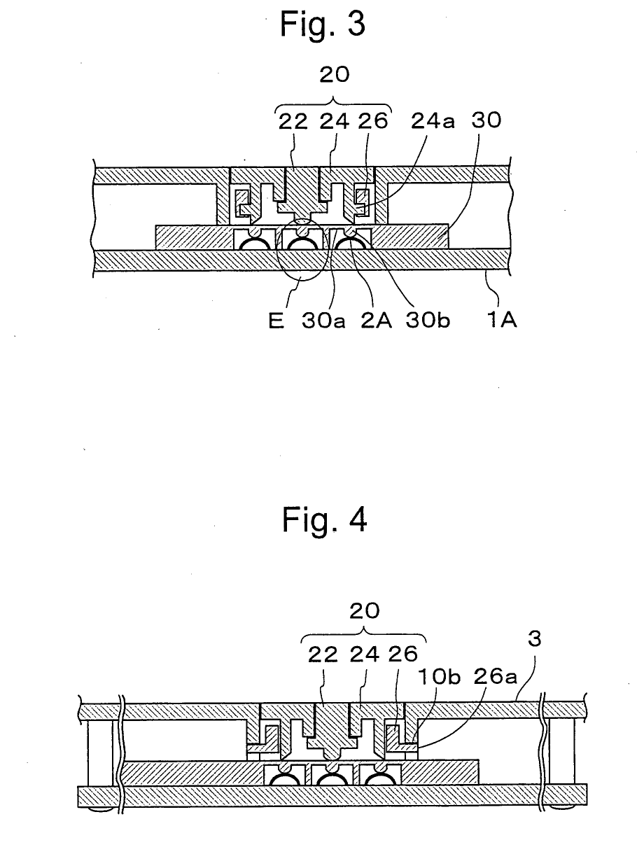

Referring to FIG. 2 to FIG. 5, the operating part 20 comprises a first rotation member 26 to be rotatably engaged with the notches 10b, a second rotation member 24 with which the first rotation member 26 is fitted based on the lateral direction orthogonal to the notches 10b, and a push key 22 which is fitted so as to penetrate the central portion of the second rotation member 24.

The first rotation member 26 has a ring shape. This first rotation member 26 comprises rotation shafts 26a which project in the longitudinal direction from the ring-shaped outer circumference and are engaged with and supported by the respective notches 10b, and a pair of rotation concavities 26b formed at lower ends in the lateral direction orthogonal to the extending direction of the rotation shafts 26a, and both rotation shafts 26a and rotation concavities 26b are integrally molded. The vertical height of the rotation shaft 26a is reduced by halving a cylinder and extending the halved-cylinder in a semicircular shape, and the vertical height of the rotation concavity 26b is also reduced by being notched into a semicircular shape in the same manner as the rotation shaft 26a.

The second rotation member 24 comprises a cylindrical part 24b that rotatably supports the rotation concavities 26b of the first rotation member 26, and an upper surface part 24c extending to a second push part 22c at the upper end of the cylindrical part 24b, and these cylindrical part 24b and upper surface part 24c are integrally molded. On the cylindrical part 24b, a rotation shaft 24a projecting in the longitudinal direction from the outer circumference of the cylindrical part 24b is integrally formed, and the vertical height of this rotation shaft 24b is also reduced by halving the circumference and extending it in a semicircular shape in the same manner as the rotation shaft 26a of the first rotation member 26. In the upper surface part 24c, a through hole 24d-10a is formed so as to penetrate the inside of the cylindrical part 24 from the center of the surface, and a push key 22 is fitted from below into this through hole 24d-10a.

The push key 22 comprises a first push part 22a formed into a disk shape, a rib 22b extending outward from the lower end of the first push part 22a, and a second push part 22c projecting downward from the center of the bottom surface of the rib 22b, and these three members of the first push part 22a, rib 22b, and second push part 22c are integrally formed.

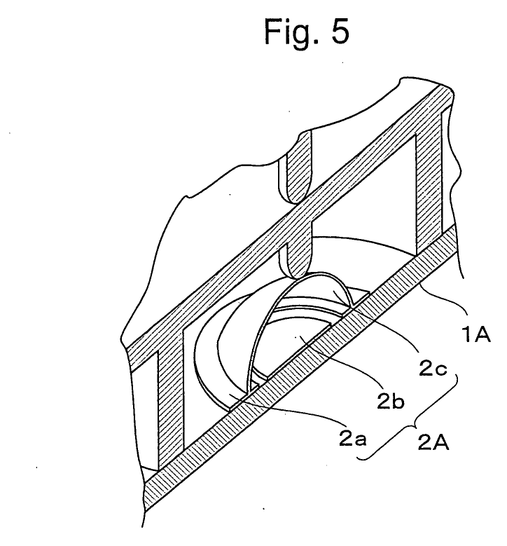

On the surface of the circuit board 1A, a circuit pattern (not shown) is fixed and formed based on a predetermined circuitry, and by providing leaf springs 2c (see FIG. 5) on this circuit pattern, nine leaf spring contacts 2A are formed. Eight of these leaf spring contacts 2A are formed along the same circumference at even intervals with phases of 45 degrees from each other around one contact that becomes opposite to the second push part 22c when the 8-directional operation key input device 4 is built up and installed in the phone main body H.

Near the leaf spring contacts 2A, an LED (not shown) is mounted. In the circuit board 1A, a plurality of screw holes 10a (four in FIG. 2) are opened for screwing the circuit board 1A on the cover 3.

The key top 30 is a rectangular thin plate part disposed on the surface of the circuit board 1A, and made from a soft material such as a silicon rubber, etc. On the back surface of this key top 30, nine concavities 30a are formed so as to adapt to forward, rearward, rightward, and leftward tilting operations by the first rotation member 26 and the second rotation member 24 and downward sinking operations by the push key 22. In other words, the leaf spring contacts 2a are partitioned by the concavities 30a, respectively, so as to independently operate within the corresponding concavities 30a. In these concavities 30a, bosses 30b that project downward from the center of the insides of the concavities are integrally formed.

On the other hand, on the surface of the key top 30, the abovementioned operation key group 5 including dial keys are integrally formed. On the back surfaces of this operation key group 5, conductors (not shown) are mounted, and these conductors short-circuit the circuit pattern of the circuit board 1A, whereby various functions of the cell phone are executed. Although not shown in the drawings, LED concavities 30a for housing and covering LEDs mounted on the circuit board 1A are formed.

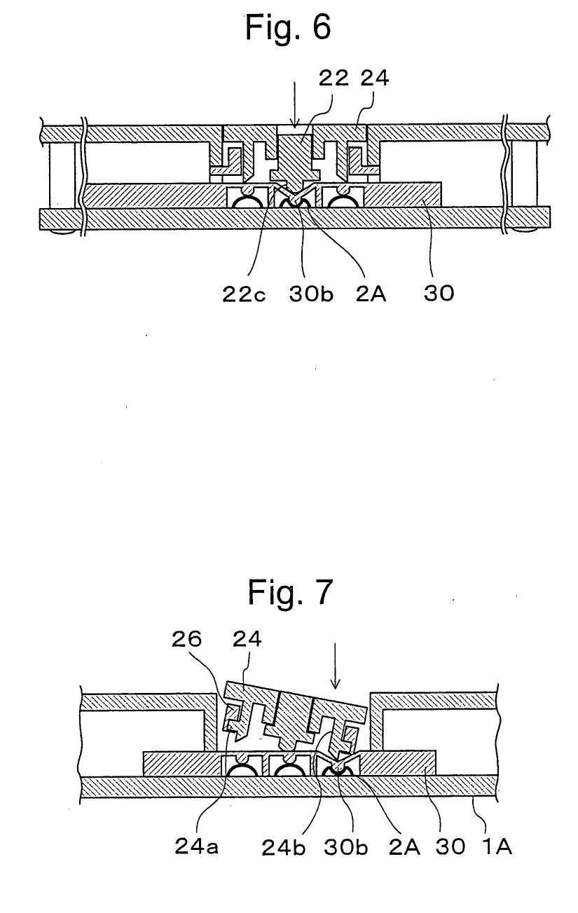

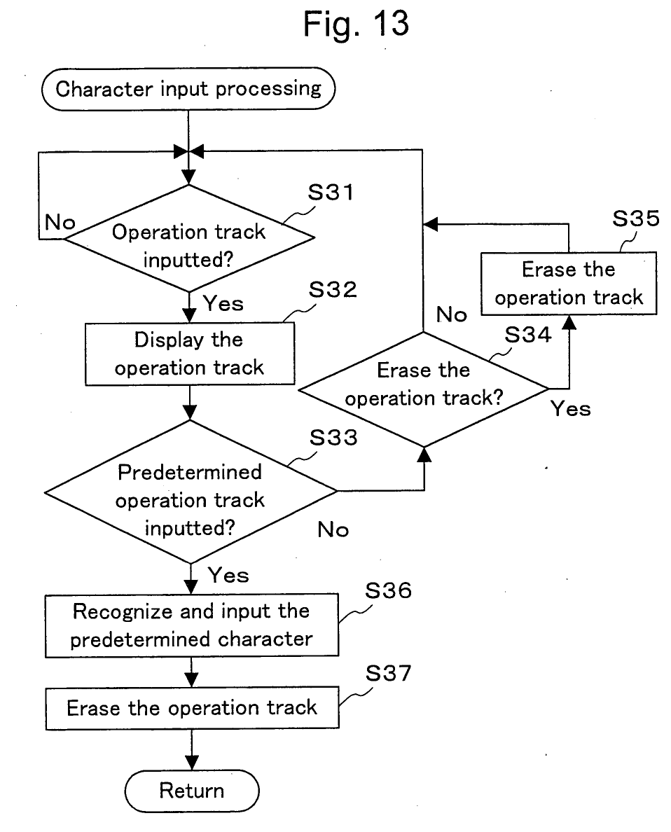

Herein, referring to FIG. 6 to FIG. 8, operations of the respective elements in response to operations of the 8-directional operation key input device 4 are described. The device can be operated in circumferential, forward, rearward, rightward, and leftward directions by operating the operating part 20 around the second push part 2c of the push key of the operating part 20. This circumferential direction is equivalent to the outer circumference of the effective movable range E shown by the dotted line in FIG. 13 and FIG. 14.

Action of the operating part 20 is described below, and not only the 8-directional operation key input device shown in this embodiment, but also a generally known multidirectional stick-type key input device that is movable in all directions of 360 degrees, adopted for the controller of PlayStation 2 produced by Sony, can be adopted, and such a multidirectional stick-type key input device movable in all directions of 360 degrees makes more various types of input patterns possible.

As shown in FIG. 6, the push key 22 sinks when it is pressed from the direction shown by the arrow in FIG. 7, and the second push part 22c applies a pressure to the upper surface of the key top 30. Then, the upper part of the key top 30 deforms due to the pressure from the second push part 22c, and the boss 30b sinks downward to the top of the leaf spring 2c (see FIG. 5) of the leaf spring contact 2A provided on the circuit board 1A. In response to this, the leaf spring 2c deforms due to the boss 30b and comes into contact with a second pattern 2b (see FIG. 5).

When the boss 30b sinks and the leaf spring 2c comes into contact with the second pattern 2b as mentioned above, a current flows from a first pattern 2a (see FIG. 5) to the second pattern 2b through the leaf spring 2c. As a result, various functions of the cell phone are executed. When the pressing is released, the push key 22 is pushed up due to elastic restitution of the key top 30 and the leaf spring 2c to the original condition (neutral).

Furthermore, the first rotation member 26 rotates in the arrow C direction (see. FIG. 2) around the rotation shafts 26a of the first rotation member 26 when the upper end of the second rotation member 24 is pressed from the arrow direction of FIG. 7. In response to this movement, the second rotation member 24 tilts as shown in FIG. 7.

When the second rotation member 24 thus tilts, the lower end of the cylindrical part 24b of the second rotation member 24 applies a pressure to the upper surface of the key top 30. Thereby, the key top 30 is pressed by the lower end of the cylindrical part 24b and the upper part of the key top deforms, and the boss 30b sinks to the top of the leaf spring 2c (see FIG. 5) of the leaf spring contact 2A provided on the circuit board 1A. In accordance with this, the leaf spring 2c deforms and comes into contact with the second pattern 2b (see FIG. 5), and a current flows from the first pattern 2a (see FIG. 5) to the second pattern 2b through the leaf spring 2c. As a result, various functions of the cell phone are executed. When the abovementioned pressure is released, both the first rotation member 26 and the second rotation member 24 rotate by being pushed up by an elastic force of the key top 30 and the leaf spring 2c and restore to the original condition.

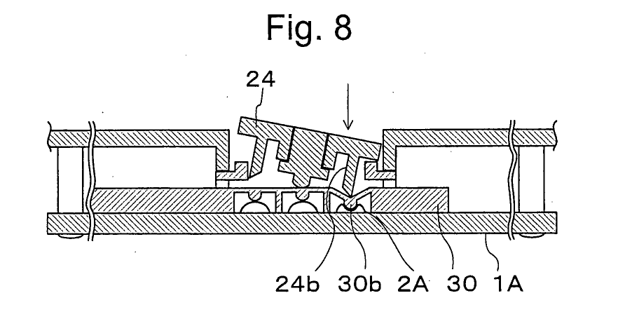

On the other hand, when the second rotation member 24 is pressed at the upper end from the arrow direction of FIG. 8, it rotates in the arrow D direction around the rotation shafts 24a, and tilts as shown in FIG. 8.

When the second rotation member 24 thus rotates and tilts, the lower end of the cylindrical part 24b of the second rotation member 24 applies a pressure to the upper surface of the key top 30. Thereby, the key top 30 is pressed by the lower end of the cylindrical part 24b and the upper part of the key top deforms, and the boss 30b sinks to the top of the leaf spring 2c (see FIG. 5) of the leaf spring contact 2A provided on the circuit board 1A. In accordance with this, the leaf spring 2c deforms and comes into contact with the second pattern 2b (see FIG. 5), and a current flows from the first pattern 2a (see FIG. 5) to the second pattern 2b through the leaf spring 2c. As a result, various functions of the cell phone are executed.

When the abovementioned pressure is released, both the first rotation member 26 and the second rotation member 24 rotate by being pushed up by an elastic force of the key top 30 and the leaf spring 2c and restore to the original condition.

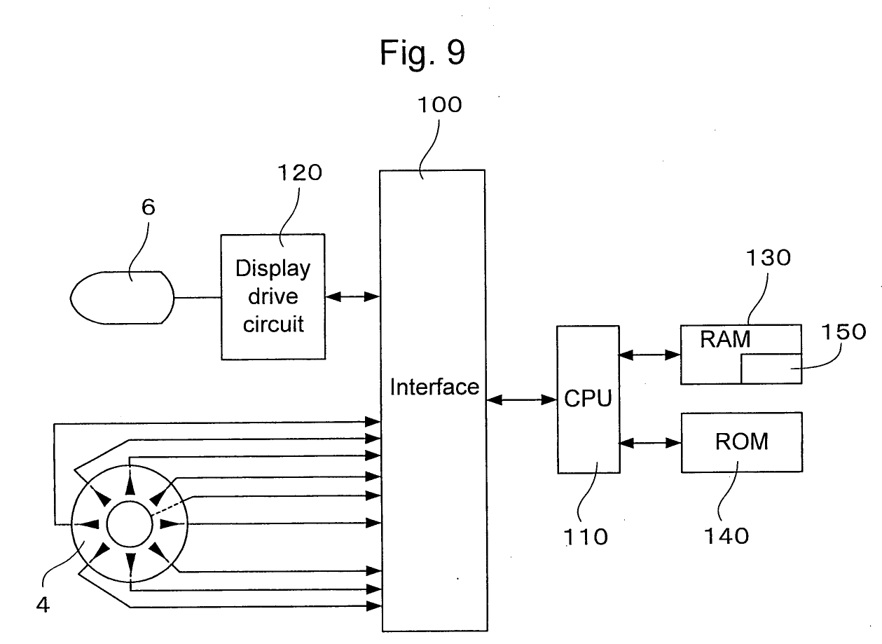

With reference to FIG. 9, an electrical construction to be used for a command input by the 8-directional operation key input device 4 is described.

In FIG. 9, the reference mark 100 denotes an interface 100, and to this interface 100, the 8-directional operation key input device 4, a CPU 110 administering the control hub, and a display 6 drive circuit 120 that is connected to the display 6 and drives this display 6 are connected. To the CPU 110, a RAM 130 and a ROM 140 are connected, and the CPU executes controlling according to a program stored in the ROM 140. This CPU 110 is supplied with an operation output of the 8-directional operation key input device 4 via the interface 100, and controls the display drive circuit 120 based on this operation output.

The RAM 130 stores various data for execution of various functions of the cell phone such as memory dial, etc. Particularly, in this RAM 130, comparison data 150 containing a required number of characters, numerals, and command codes is stored.

The ROM 140 stores various control programs for processing various functions of the cell phone.

Particularly, the control program contains: a recognition program as a recognition means for recognizing an input command when a character, numeral, or command code is inputted by tilting and pressing the operating part 20 of the 8-directional operation key input device 4 by comparing an operation track L of the operating part 20 of the 8-directional operation key input device 4 according to the input operation of each code composing the command code and each code composing a character, numeral, or command code stored in the comparison data 150; a display control program for making the display 6 as a display device to display, when an input command is inputted by a recognition program, a display image related to the command code, and when the input command code is not recognized, display it; a template display program for making the display 6 to display a reference guide mark P that restricts operations so that the operation track L falls within a certain range E (within the circle shown by the reference mark E of FIG. 14 in this embodiment), and, with respect to the reference guide mark P, to overwrite and display the operation track L of the key input device 4 on the range E; and a restriction program that controls so as to prevent an operation track from being displayed on the display 6 when the operating part 20 is operated beyond the reference guide mark.

Particularly, the template display program and the restriction program can be operated as if a generally known mouse pointer of Windows software provided by Microsoft moves within the display screen, and the program controls by defining an aggregation of movement tracks of a mouse pointer (pointer image) as an operation track L so that the track is continuously displayed until each code input is settled.

In this embodiment, as shown in FIG. 14 to FIG. 16, the pointer image (equivalent to a mouse pointer) is not shown although the operation track L of each code is shown, however, the aggregation of the movement tracks of the pointer image is the operation track L.

Herein, a processing routine relating to a command input by the 8-diectional operation key input device 4 is described.

First, a flow of processing for inputting a command code serving as a trigger of execution of a function which locks the cell phone and releases the lock condition (hereinafter, referred to as “lock setting/releasing function”) among the functions provided for the cell phone is described.

Herein, “code” includes an aggregation of characters or numerals, or command codes which are composed of hieroglyphic mnemonic symbols and serve as triggers of execution of various functions.

Furthermore, it is assumed that in the comparison data 150, a lock setting/releasing code was registered at the time of shipping or the lock setting/releasing code at the time of shipping was changed by key operations by a user and the changed code was registered.

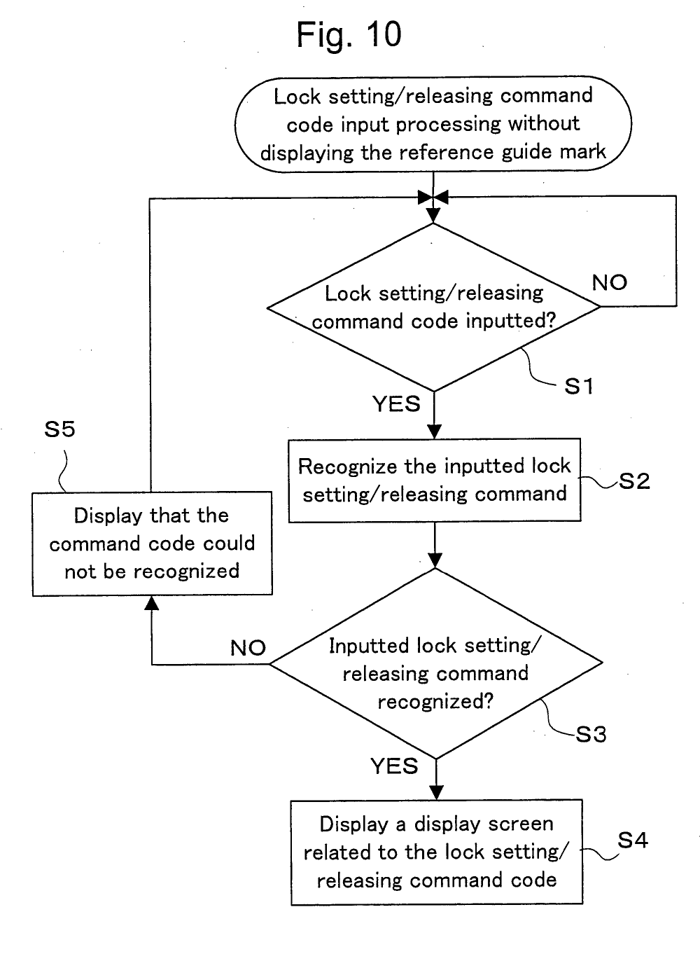

Referring to FIG. 10, first, the CPU 110 judges based on an operation output of the 8-directional operation key input device whether or not a lock setting/releasing code has been inputted by operation of the operating part 20 of this operation key input device 4 so that its operation track L draws each code composing the code (Step S1). This judgment processing is executed for settlement by a pressing operation (hereinafter, referred to as a settlement operation) of the push key 22 of the operating part 20 of the 8-directional operation key input device 4 after the input of the command code is finished.

In Step S1, when it is judged that the lock setting/releasing code has been inputted, the CPU 110 compares the operation track L of the operating part 20 of the 8-directional operation key input device 4 in accordance with the input operation of each code composing the code and each code composing a lock setting code stored and registered in advance in the comparison data 150, recognizes the input command (Step S2), and judges whether or not the input code has been recognized (Step S3).

At this point, the display 6 displays the image as shown in FIG. 14 to FIG. 16 when the corresponding code is inputted (Step S2). Such display is made according to the abovementioned template display program, however, the display can be canceled by a display/non-display switch (not shown) provided in the input device of the cell phone. By switching this display/non-display switch, an interrupt command is supplied to the template display program and the process jumps to an interrupt processing program stored in the ROM 140, and interrupt control by the CPU 110 is started.

Such a display/non-display switch is not always essential; however, a non-display mode established by this switch makes it possible to input a command code composed of characters, numerals, or other hieroglyphic figures by an operation of the operation key input device 4 without displaying the reference guide mark. Such input without displaying the reference guide mark has an advantage in that other persons are prevented from stealing a glance at the code.

In Step S3, in a case were the input command is recognized, the CPU 110 operates the display drive circuit 120 to display a display image related to this code on the display 6 (Step S4).

A concrete example of this display image is, in a case where a user inputs a code for locking, a character screen displaying “Auto lock”, or in a case where a code is inputted for releasing the lock, a character screen displaying “Lock release” or a non-display image (normal call waiting screen) that does not especially notify the release. On the other hand, when the input code is not recognized, the CPU 110 displays it on the display 6 (Step S5), and then returns the process to Step S1.

Next, the flow of processing of inputting a command code serving as a trigger of a function for displaying on the display 6 a shortcut menu related to functions available with the cell phone in a required status (hereinafter, referred to as “shortcut menu display function”) is described.

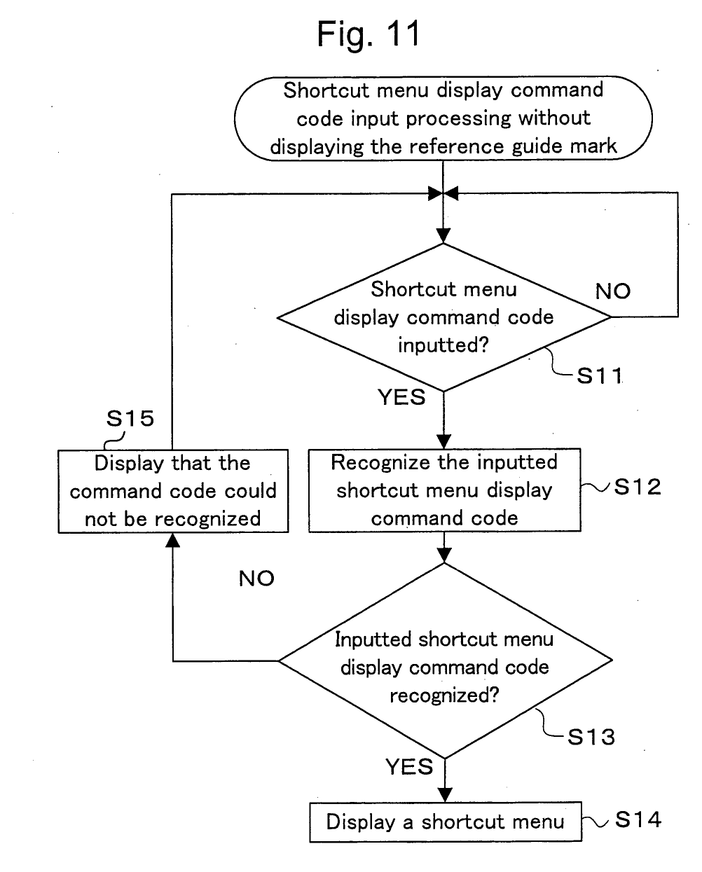

Referring to FIG. 11, first, the CPU 110 judges based on an operation output of the 8-directional operation key input device 4 whether or not a shortcut menu display code has been inputted by operating the operating part 20 of this operation key input device so that its operation track draws each code composing the code, and displays a reference guide mark P and an operation track L for drawing each code on the display 6 (Step S11). This judgment processing is executed upon settlement of the operating part 20 of the 8-directional operation key input device after input of the abovementioned code is finished.

In Step S11, when it is judged that the shortcut menu display code has been inputted, the CPU 110 compares the operation track of the operating part 20 of the 8-directional operation key input device 4 according to the input operation of each code composing the code and each code composing a lock setting code stored and registered in advance in the comparison data 150 (Step S12), recognizes the input (Step S12), and judges whether or not the input code has been recognized (Step S13).

In Step S13, in a case where the input command has been recognized, the CPU 110 operates the display drive circuit 120 to display a display image related to this code on the display 6 (Step S14). On the other hand, when the input code is not recognized, the CPU 110 displays it on the display 6 (Step S15), and thereafter, returns the process to Step S11.

Subsequently, the flow of processing of inputting a code serving as a trigger of execution of a function for displaying a bookmark menu in which URLs of web pages that are frequently accessed have been registered on the display 6 (hereinafter, referred to as “bookmark menu display function”) is described.

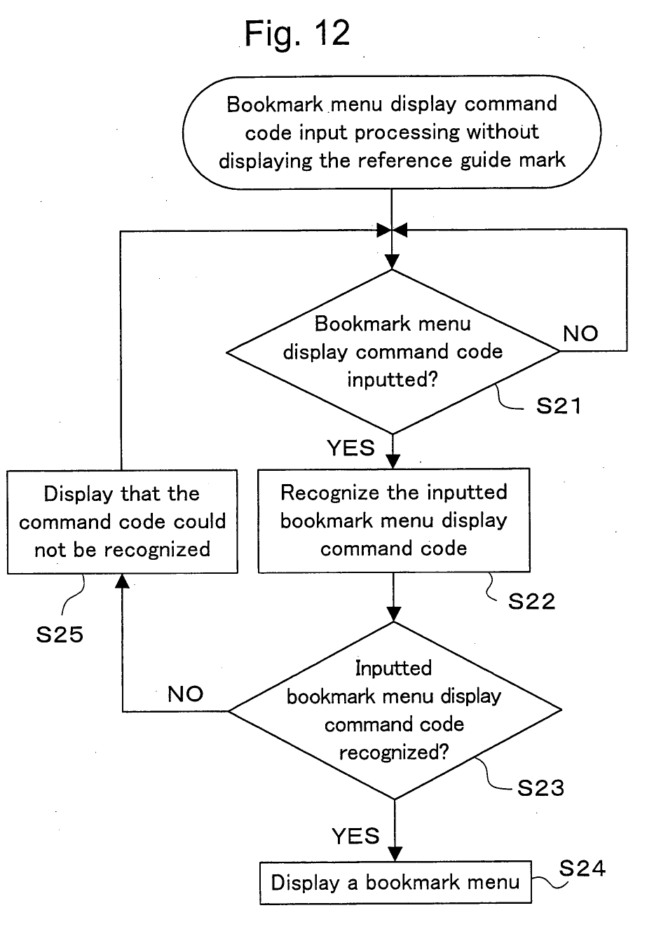

Referring to FIG. 12, first, the CPU 110 judges based on an operation output of the 8-directional operation key input device 4 whether or not a bookmark menu display code has been inputted by operating the operating part 20 of this operation key input device so that its operation track L draws each code composing the code as shown in FIG. 14 to FIG. 16, and displays a reference guide mark P and an operation track L for drawing each code on the display 6 (Step S21). This judgment processing is executed upon settlement of the operating part 20 of the 8-directional operation key input device 4 after input of the abovementioned code is finished.

In Step S21, when it is judged that the bookmark menu display code has been inputted, the CPU 110 compares the operation track of the operating part 20 of the 8-directional operation key input device 4 according to the input operation of each code composing the code, and each code composing the lock setting code registered in the comparison data 150, recognizes the input (Step S22), and judges whether or not this input code has been recognized (Step S23).

In Step S23, in a case where the input command has been recognized, the CPU 110 operates the display drive circuit 120 to display a display image related to this code on the display 6 (Step S24). Meanwhile, when the input code is not recognized, the CPU 110 displays it on the display 6 (Step S25), and thereafter, returns the process to Step S21.

Character input processing relating to the embodiment of the invention is described with reference to FIG. 13. Only the case where a character is inputted is described below, however, the same applies to input of a numeral.

First, it is judged whether or not an operation track has been inputted (Step S31). For input of an operation track, a user tilts and presses the operating part of the 8-directional operation key input device 4 so as to draw a character, a numeral, or each code composing a symbolized command code such as a hieroglyphic character, etc., whereby an operation track according to the operation of the 8-directional operation key input device 4 is inputted.

On the other hand, when it is judged that no operation track is inputted, the status waits for input of an operation track.

Next, when an operation track according to the operation of the 8-directional operation key input device 4 is inputted, this operation track is displayed on the display 6 (Step S32). On the display 6, a reference guide mark shown in FIG. 14A is displayed, and a pointer in a certain region of this reference guide mark moves in response to operation of the 8-directional operation key input device 4 to draw an operation track, and the operation track is overwritten and displayed on the reference guide mark. At this point, operation information of the 8-directional operation key input device 4 shown in FIG. 9 is successively transmitted to the RAM 130 through the interface 100 under the control of the CPU, and the successively transmitted operation information is made to be a series to compose operation track information. Then, in a condition where this operation track information is temporarily stored in the RAM 130, the operation track information is transmitted to the display drive circuit 120, whereby the operation track is displayed on the display 6. In a condition (non-display mode) where the operation track is not displayed on the display 6, the operation track information is only temporarily stored in the RAM 13, and is not transmitted to the display drive circuit 120.

Operation track input and display are thus carried out, and it is judged whether or not the predetermined operation track has been inputted (Step S33).

Herein, when it is judged that the predetermined operation track has been inputted, a predetermined character corresponding to this operation track is recognized and inputted (Step S36). The inputted character may be displayed on the display 6.

When the predetermined character is recognized and inputted in Step S36, the operation track displayed on the display 6 is erased (Step S37) and this subroutine is ended. At this point, the operation track information that has already been stored in the RAM 130 is erased, and the new operation track information is transmitted to the display drive circuit 120 and the operation track is displayed on the display 6, whereby the operation track corresponding to the erased operation track information is erased from the display 6. In the condition (non-display condition) where the operation track is not displayed on the display 6, the operation track information that has already been stored in the RAM 130 is only erased, and the new operation track information is not transmitted to the display drive circuit 120.

On the other hand, when it is judged that the predetermined operation track is not inputted in Step S33, the process further waits for input of an operation track, and even in this case, it is judged whether or not the operation track that has already been inputted is to be erased (Step S34). When it is judged that the operation track is to be erased, the operation track is erased (Step S35), and the process returns to Step S31, however, when it is judged that the operation track is not to be erased, the process immediately returns to Step S31. The system of erasing the operation track is the same as in Step S37 mentioned above.

Erasing of an operation track in Step S34 may be carried out in a manner in that when a predetermined period of time elapses, operation tracks that have already been inputted are erased all at once, or information related to too many operation tracks to be stored in the memory is erased in order from the older one, and any erasing manner can be used.

In the embodiment of the invention, by tilting and pressing the operating part 20 of the 8-directional operation key input device 4 so that its operation track L draws a character, a numeral, or each code composing a symbolized command code such as a hieroglyphic character, etc., the character, the numeral, or the command code can be inputted. Therefore, it is also possible that a character, a numeral, or a command code is inputted through a so-called input operation in which the operating part 20 of the 8-directional operation key input device 4 is operated in the user's own image of each code of the command imagined in her/his mind. Furthermore, even when it is difficult to create an image according to the user's own mind and operate the operating part 20 of the 8-directional operation key input device 4 in the image, an operation track L is overwritten and displayed on the abovementioned circular reference guide mark P on the display 6. Therefore, even a user who is not good at operating without displaying the reference guide mark can easily carry out the operation.

Thereby, an input operation of a character, a numeral, or a command code can be simplified, and this contributes to further improvement in multi-functionality of the cell phone without an increase in the number of operation keys. For example, as seen in FIG. 14 to FIG. 16, input of a letter is achieved by only one multidirectional input device. In addition, in a case where the character, the numeral, or the command code is an authentication code related to the lock setting/releasing function, the code can be composed as a systematic aggregation including a combination of a character/numeral and a figure. As a result, the authentication code related to security has originality, whereby security is enhanced.

When a code is inputted by operation of the operating part 20 of the 8-directional operation key input device 4, the CPU 10 compares an operation track L of the operating part 20 of the 8-directional operation key input device 4 according to an input operation of each code composing the command code and a each code composing a character, numeral, or command code stored and registered in advance in the comparison data 150, and recognizes the input. At this point, when a predetermined input is recognized, the CPU 110 displays a display image related to this predetermined input on the display 6. On the other hand, when a predetermined input is not recognized, the CPU 110 displays it on the display 6. Therefore, a user can know the results of the input operation. As a result, the user quickly becomes used to input operations using the 8-directional operation key input device.

Furthermore, the 8-directional operation key input device 4 is disposed below the display device at almost the center in the width direction of the phone main body H so that a command input operation by using this multi-directional operation key input device by a thumb becomes easy when a user holds the phone main body H for communications. Therefore, an input operation of a character, a numeral, or a command code by a thumb becomes easy. As a result, accuracy of the input operation increases.

### INDUSTRIAL APPLICABILITY

The invention simplifies an input operation of a character, a numeral, or a symbolized mark such as a hieroglyphic character, etc., by using a multidirectional input device, and thereby, it contributes to further improvement in multi-functionality without an increase in the number of operation keys. Furthermore, by displaying a reference guide mark serving as a standard for these inputs, even an input operator who is inexperienced in input operations can carry out input operations and can become gradually accustomed to input operations.

1. An input device for inputting characters, numerals, or command codes that serve as triggers of execution of various functions into an electronics device with a display device that displays required information,
wherein a multidirectional operation key input device having an operating part that can be operated in a multidirectional manner is included, and a predetermined character, numerator command code serving as a trigger of execution of various functions is inputted by operating the operating part of the multidirectional operation key input device so as to draw a predetermined operation track.

2. The input device according to claim 1, wherein the display device displays a reference guide mark which restricts the operation track within a certain range, and displays an operation track according to an operation of the multidirectional operation key input device on the reference guide mark.

3. The input device according to claim 2, wherein an operation track drawn on the reference guide mark is continuously displayed until input of a predetermined character, numeral, or command coda serving as a trigger of execution of various functions is completed, and when input of this predetermined character, numeral, or command code serving as a trigger of execution of various functions is completed, this operation track is erased.

4. The input device according to claim 1, wherein the operating part of the multidirectional operation key input device is formed into an 8-directional operation key input device that can be tilted and pressed forward, rearward, rightward, and leftward, or a multidirectional stick-type key input device that is movable 360 degrees.

5. The input device according to claim 1, further including;
comparison date storing characters, numerals, or command codes that serve as triggers of various functions;
a recognition means for recognizing, a character, a numeral, or a command code corresponding to an inputted operation track by comparing the operation track of the operating part of the multidirectional operation key input device according to the input operation of the predetermined character, numeral, or command code and a character, a numeral, or a command code stored in advance in the comparison data in response to the operation of the operating part of the multidirectional operation key input device; and
a display control means for making the display device to display a display image related to the character, the numeral, or the command code when the inputted character, numeral, or command code is recognized by this recognition means.

6. The input device according to claim 1, wherein the multidirectional operation key input device has an operating part which can be operated in a multidirectional manner, that is, at least in forward, rearward, rightward, leftward, and circumferential directions, and
by operating the operating part of the multidirectional operation key input device so as to draw a predetermined operation track, that is, an operation track describing a character, a numeral, or a command code itself to be inputted by moving operations forward, rearward, rightward, leftward and circumferential directions of the operating part, this character, numeral, or command code is inputted.

7. The input device according to claim 1, wherein
the input device is provided in a cell phone, and has, as the command codes, at least one of the command codes for.
(i) locking and releasing the lock,
(ii) displaying a shortcut menu related to functions of the cell phone which can be used In necessary conditions on the display device,
(iii) dleplayfng a bookmark menu in which internet addresses of web pages which are frequently accessed have been registered on the display device,
(iv) displaying an address book in which private information including telephone numbers and e-mail addresses have been registered on the display device,
(v) displaying dial history indicating history of dIallng by the call phone on the display device,
(vi) displaying received call history indicating history of calls received by the call phone on the display device,
(vii) displaying incoming mails received by the cell phone on the display device, and
(viii) displaying outgoing mails transmitted by the cell phone on the display device.

8. An input method for inputting a character, a numeral, or a command code serving as a trigger of execution of various functions into an electronics device including a display device for displaying required information and a multidirectional operation key input device with an operating part that can be operated forward, rearward, rightward, and leftward, including:
an input step for inputting a predetermined character, a numeral, or a command code servinges a trigger of execution of various functions by operating the operating part of the multidirectional operation key input device so as to draw a predetermined operation track.

9. The input method according to claim 8, wherein for a reference guide mark that restricts the operation track within a certain range, a range of an effective movable operation region of the operating part of the multidirectional operation key input device is set, the method further including a step in which, the operation track that moves in the range of the region according to an operation track of the multidirectional operation key input device is capable of being overwritten and displayed in the range.

10. The input method according to claim 9, Including: a stop in which an operation track to be drawn on the reference guide mark is continuously displayed until input of a predetermined character, a numeral, or a command code serving as a trigger of execution of various functions is completed; and a step in which the track is erased when input of the predetermined character, the numeral, or the command code serving as a trigger of execution of various functions is completed.

11. The input method according to claim 8, wherein the operating part of the multidirectional operation key input device is an 8-directional operation key input device that can be tilted and pressed forward, rearward, rightward, and leftward, or a multidirectional stick-type key input device movable 360 degrees, and input can be made by tilting and pressing the operating part forward, rearward, rightward, and leftward.

12. The input method according to claim 8, further including:
a recognition stop in which in response to operation of the operating part of the multidirectional operation key input device, a character, a numeral, or a command code corresponding to the inputted operation track is recognized by comparing the operation track of the operating part of the multidirectional operation key input device according to the input operation of the predetermined character, the numeral, or the command code and comparison data of a character, a numeral, or a command code stored in advance; and
a display control stop in which the display device is made to display a display image related to the character, the numeral, or the command code when the inputted character, numeral, or command code is recognized by this recognition step.

13. The input method according to claim 8, wherein
the multidirectional operation key input device has an operating part that can be operated in a multidirectional manner, that is, at least in the forward, rearward, leftward, rightward, and circumferential directions, and an input step is included in which a predetermined character, a numeral, or a command code is inputted by operating the operating part of the multidirectional operation key input device so as to draw an operation track describing the character, the numeral, or the command code itself to be inputted by moving operations of the operating part in forward, rearward, rightward, leftward, and circumferential directions.

14. The input method according to claim 8, wherein the input device is provided in a cell phone, and has, as the command codes, at least one of the command codes for:
(i) locking and releasing the lock,
(ii) displaying a shortcut menu related to functions of the cell phone which can be used in necessary conditions on the display device,
(iii) displaying a bookmark menu in which Internet addresses of web pages which are frequently accessed have been registered on the display device,
(lv) displaying an address book in which private information including telephone numbers and e-mail addresses have been registered on the display device,
(v) displaying dial history indicating history of dialing by the cell phone on the display device,
(vi) displaying received call history indicating history of calls received by the cell phone on the display device,
(vii) displaying incoming malls received by the cell phone on the display device, and
(viii) displaying outgoing mails transmitted by the call phone on the display device.
